(19) United States
(12) Patent Application Publication
(10) Pub. No.: US 2026/0212632 A1
(43) Pub. Date: Jul. 23, 2026

(54) UNSUPERVISED IDENTIFICATION OF THE KEY ENDMEMBERS IN MULTI- AND HYPERSPECTRAL REMOTE SENSING IMAGES FOR IMAGE SEGMENTATION AND ANALYSIS

(71) Applicant: Saudi Arabian Oil Company, Dhahran (SA)

(72) Inventors: Sabbir Rahman, Dhahran (SA); Frankly Leonardo Toro Gonzalez, Thuwal (SA)

(21) Appl. No.: 19/033,123

(22) Filed: Jan. 21, 2025

(51) Int. Cl. G06V 10/26; G06V 10/44; G06V 10/762; G06V 10/764; G06V 20/10

(52) U.S. Cl. CPC G06V 10/26; G06V 10/443; G06V 10/7625; G06V 10/764; G06V 20/194

(57) ABSTRACT

Systems and methods for material classification using multispectral images of regions of interest. The multispectral image includes aerial images of the region of interest captured by a multispectral sensor. The multispectral image is processed by applying a multidimensional edge detection filter to remove a portion of the plurality of pixels identified as impure pixels. The remaining portion of the pixels includes unmasked samples. A Euclidian minimum spanning tree of unmasked samples is determined. The unmasked samples are rotated to minimize a dimension of the unmasked samples. A single-link clustering is applied to generate a dendrogram of pure materials. A cluster quality index is determined for each cluster to sort the pure materials in order of significance and to select a portion of the pure materials as key materials based on the order of significance. A spectral unmixing procedure is applied to generate a map of the key materials.

### TECHNICAL FIELD

The present disclosure is generally related to material classification and, more specifically, to unsupervised identification of the key endmembers in multi- and hyperspectral remote sensing images for image segmentation and analysis.

### BACKGROUND

High-dimensional multispectral and hyperspectral images include a variety of information about the materials present in a region of interest. Every pixel in the image is represented by a vector of D numbers representing the energy radiated in D spectral bands that typically range in frequency from ultra-violet through the visible spectrum to short wave infrared, and these radiated spectra are unique to the material(s) present in that pixel. Some models consider the set of spectra as represented within a D-dimensional feature space and apply a traditional partitional clustering algorithm to the samples to divide the samples into a pre-determined number of clusters, which are used to represent the materials present. The traditional partitional clustering algorithm presents a number of problems as the obtained clusters tend to be equal-sized and spheroidal shaped, incorrectly capturing the natural geometry of the actual clusters present within a region. The equal sized clustering defines a non-intuitive and unnatural segmentation of the image, in which either a number of different materials are assigned to a single cluster, or a single material is broken up into multiple clusters.

### SUMMARY

Implementations of the present disclosure are directed to material classification. More particularly, implementations of the present disclosure are directed to unsupervised identification of the key endmembers in multi- and hyperspectral remote sensing images for image segmentation and analysis.

In some implementations, a method includes: receiving a multispectral image corresponding to a region of interest, the multispectral image including aerial images of the region of interest captured by a multispectral sensor, the multispectral image includes a plurality of pixels; processing the multispectral image, by applying a multidimensional edge detection filter to remove a portion of the plurality of pixels identified as impure pixels, a remaining portion of plurality of pixels including unmasked samples; determine a Euclidian minimum spanning tree of unmasked samples, wherein the unmasked samples are rotated to minimize a dimension of the unmasked samples; applying a single-link clustering to generate a dendrogram of pure materials; determining a cluster quality index for each cluster to sort the pure materials in order of significance and to select a portion of the pure materials as key materials based on the order of significance; applying a spectral unmixing procedure to generate a map of the key materials in the multispectral image; and identifying an action plan to remedy a risk associated with the map of key materials.

The foregoing and other implementations can each optionally include one or more of the following features, alone or in combination. In particular, implementations can include all the following features:

In a first aspect, combinable with any of the previous aspects, wherein each pixel of the plurality of pixels having an associated spectrum consisting of a plurality of dimensions. Applying the multidimensional edge detection filter can include locally normalizing edges and subpixel anomalies within the multispectral image using a volatility map, and applying an edge filter mask to remove a portion of the edges and an anomaly filter mask to remove a portion of the subpixel anomalies to generate a map of pure pixels which remain unmasked. Applying the single-link clustering can include applying a hierarchical clustering algorithm to the map of pure pixels to generate a dendrogram including the clusters of pure materials. Identifying and selecting the key materials can include calculating a size quality index and a height quality index for each non-leaf cluster in the dendrogram, combining the size quality index and the height quality index to calculate an overall cluster quality index for each cluster, sorting the clusters in descending order of cluster quality index to generate sorted clusters, and selecting a portion of the sorted clusters as the key materials or endmembers used for subsequent processing. The spectral unmixing procedure is applied to generate a map of key materials in the multispectral image. The computer-implemented method further can include comparing to the map of materials to a past map of materials to determine a material change pattern. Identifying the action plan can include determining a risk associated with the material change pattern, and generating an alert indicative of the risk associated with the material change pattern. Identifying the action plan can include activating an equipment to clean or protect one or more points of interests identified to be affected by the material change pattern.

Other implementations of the aspect include corresponding systems, apparatus, and computer programs, configured to perform the actions of the methods, encoded on computer storage devices.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features described herein, but also include any combination of the aspects and features provided.

Implementations described in the present disclosure, provide an accurate identification and masking of mixed pixels, facilitating the application of clustering algorithms to pure pixels that represent distinct and homogenous material features. The described approach efficiently removes the noise associated with mixed pixels, providing the advantage of significantly improving the separation of clusters in the feature space, resulting in more precise and stable cluster formation. The cluster formation improvement of the described implementations is particularly significant for density-seeking hierarchical clustering algorithms, such as single-link clustering, which are sensitive to noise, especially in the region between clusters. Another advantage of the described technology is that it ensures that only high-quality, non-mixed pixels are considered at all scales in the image, the segmentation process becoming more robust, producing clearer and more meaningful segmentations that better represent the range of materials in the image. The described technology substantially improves over existing methods in that it retains spectra representing pure materials that lie close to the boundaries of the pure clusters. The described technology provides a valuable tool for accurate multi/hyperspectral image analysis and interpretation with respective myriad applications. Another advantage of the described technology is that the described mapping of materials can trigger automatic operations for systems and machines configured to maintain environmental safety and system operability.

The details of one or more implementations of the subject matter of the specification are set forth in the accompanying drawings and the description below. Other features, aspects, and advantages of the subject matter can become apparent from the description, the drawings, and the claims.

### DESCRIPTION OF THE DRAWINGS

The accompanying drawings, which are incorporated in and constitute a part of this specification, show particular aspects of the subject matter disclosed herein and, together with the description, help explain some of the principles associated with the disclosed implementations. In the drawings,

FIG. 1A is a block diagram of an example system that can be used to execute implementations of the present disclosure.

FIG. 1B is a block diagram of a portion of the example system that can be used to execute implementations of the present disclosure.

FIG. 2A illustrates an example of a multi- or hyperspectral image, according to some implementations of the present disclosure.

FIG. 2B illustrates an example 2-dimensional scatterplot of the first two principal components of the 12-dimensional spectra from image in FIG. 2A, according to some implementations of the present disclosure.

FIG. 2C illustrates an example representation of a combined mixed pixel mask applied to the image in FIG. 2A, according to some implementations of the present disclosure.

FIG. 2D illustrates an example of false color image of top 8 clusters, according to some implementations of the present disclosure.

FIG. 2E illustrates example false color image of top 64 clusters, according to some implementations of the present disclosure.

FIG. 2F illustrates example false color image of top 1378 clusters, according to some implementations of the present disclosure.

FIG. 3A illustrates an example dendrogram resulting from hierarchical clustering, according to some implementations of the present disclosure.

FIG. 3B illustrates an example cluster quality index for a simple dendrogram, according to some implementations of the present disclosure.

FIG. 4 is a flowchart illustrating an example process for material classification, in accordance with some example embodiments.

FIG. 5 depicts a block diagram illustrating a computing system, in accordance with some example embodiments.

When practical, like labels are used to refer to same or similar items in the drawings.

### DETAILED DESCRIPTION

The following detailed description describes techniques for material classification. More particularly, implementations of the present disclosure are directed to unsupervised identification of the key endmembers in multi- and hyperspectral remote sensing images for image segmentation and analysis. The described implementations provide methods and systems for automatically extracting a complete hierarchy of all key materials present in a multispectral image. A single link clustering is applied to generate a dendrogram of pure materials. The dendrogram of pure materials is used to determine cluster quality index of nodes. The cluster quality index of nodes is used to select a target number of ‘endmembers’ which can subsequently be used for image segmentation, materials mapping, classification, and/or anomaly detection.

Some traditional material classification algorithms apply hierarchical agglomerative clustering to a number D of dimensional samples in feature space. The agglomerative clustering results in a dendrogram, which encodes a hierarchy of clusters and aims to capture the hierarchical structure of the materials present. Difficulties in capturing the hierarchical structure of the present materials are given by “mixed” pixels, which contain more than one material and therefore have spectra that do not naturally belong to a single particular material cluster. Hierarchical clustering algorithms tend to be prohibitively expensive in terms of the computational resources required limiting the application to analysis of large images. The selection of the hierarchical clustering method defines whether the actual structure of the clusters in feature space is preserved. Assuming that all of the described difficulties have been overcome, the result of hierarchical clustering an N-pixel image includes an enormous binary tree, or dendrogram that contains a total of 2N−1 clusters, of which the N leaf nodes correspond to the single-point clusters while the N−1 branches correspond to the multi-point clusters. If the number of samples in the image exceeds, for example, one million pixels—which is often the case—the result includes over two million clusters. The large number of materials can be completely overwhelming for any kind of practical useful segmentation of the image, leading to processing challenges in selecting from this vast number of clusters a meaningful subset of materials that provide a practical application.

The techniques described in the present disclosure provide a solution addressing the material classification using automatic extraction of the most meaningful clusters in a processed multispectral image for the key materials present to be identified in a completely unsupervised manner. The described approach is based on a way of quantifying the quality of each cluster using a cluster quality index, which facilitates automatic ranking of the clusters present in the dendrogram in a meaningful way. A number of clusters C of interest can be automatically selected based upon a number of samples present. The materials can constitute the spectral library of key endmembers that can be used to segment the image. The described approach addresses the challenges of traditional approaches by using advanced filters to mask out “impure” pixels, thereby improving the quality of the extracted endmembers and significantly reducing the amount of computation required. As another advantage, the described approach introduces a measure of cluster quality for every branch in the single-link clustering dendrogram that facilitates a selection of a hierarchy of clusters. The clusters are ranked by quality rather than partitioning the dendrogram into poor quality non-intersecting clusters by cutting at a specific height or otherwise as is traditionally done, facilitating automatic selection of an appropriate number of the highest quality clusters for a given number of samples and generation of the associated spectral library of endmembers in a completely unsupervised manner. The described cluster quality index can be applied to multi- and hyperspectral images or, generally, to the nodes in any dendrogram resulting from agglomerative or divisive hierarchical clustering of any dataset in order to extract the most significant clusters in ranked order. The described approach also provides technical improvements related to minimized storage requirements and minimized computational complexity.

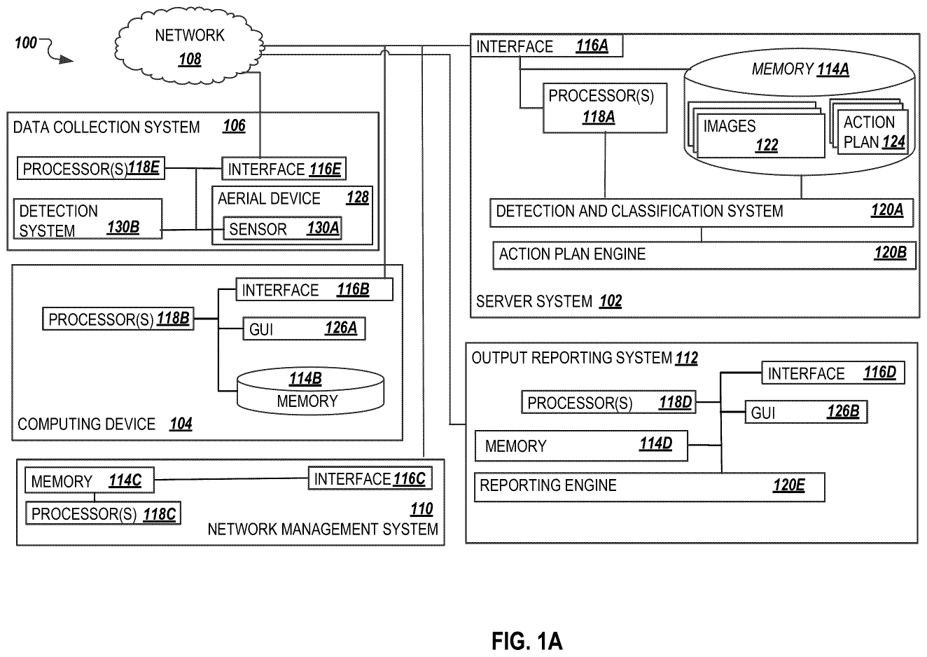

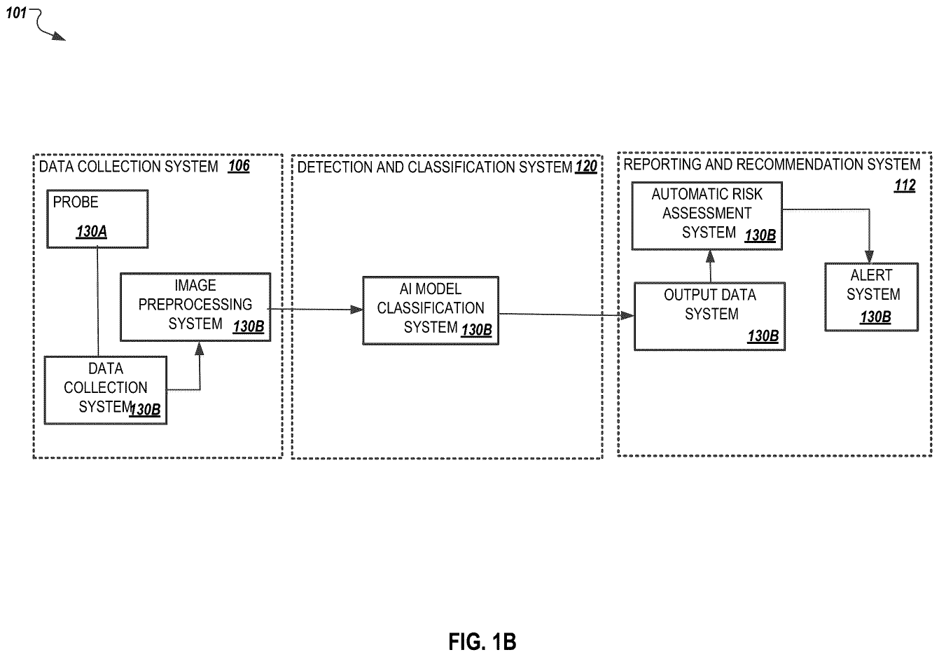

FIG. 1A is a block diagram illustrating an example system 100 that can be used to execute implementations of the present disclosure. For example, example system 100 can be configured to execute clustering algorithms for extraction of a complete hierarchy of materials present in a multi- or hyperspectral image. The illustrated example system 100 includes or is communicably coupled with a server system 102, a computing device 104, a data collection system 106, a network 108, a network management system 110, and an output reporting system 112. Although shown separately, in some implementations, functionality of two or more systems or components of the example system 100 may be provided by a single system or server. In some implementations, the functionality of one illustrated system, server, or component may be provided by multiple systems, servers, or components, respectively.

In the example of FIG. 1A, the server system 102 is intended to represent various forms of servers including, but not limited to a web server, an application server, a proxy server, a network server, and/or a server pool. In general, the server system 102 manages clustering algorithms for unsupervised segmentation of multispectral images. In accordance with implementations of the present disclosure, and as noted above, the server system 102 can host a solution environment that can be a cloud environment providing software applications, systems, and services that can be consumed by customers as a service. In some implementations, the server system 102 can support configuring of various tenants of different types, as well as services of different types that are integrated in customer integration scenarios and support execution of defined processes.

For example, the server system 102 includes a memory 114A, an interface 116A, a processor 118A, and a detection and classification system 120 and an action plan engine 120B. The memory 114A can include multispectral images 122 and action plans 124. The multispectral images 122 include data measured by and received from the data collection system 106. The multispectral images 122 can include images detected by aerial sensors. The multispectral images 122 can be processed by the detection and classification system 120A to generate material maps that are processed by the action plan engine 120B to generate action plans 124. The action plans 124 in the memory 114A can include action plan documents defining remedial operations performed by systems and machine for management and redistribution of materials.

The computing device 104, the network management system 110, and the output reporting system 112 may each be any computing device operable to connect to or communicate in the network(s) 108 using a wireline or wireless connection. In general, each of the computing device 104, the network management system 110, and the output reporting system 112 includes an electronic computer device operable to receive, transmit, process, and store any appropriate data associated with the example system 100 of FIG. 1A. Each of the computing device 104, the network management system 110, and the output reporting system 112 is generally intended to encompass any client computing device such as a laptop/notebook computer, wireless data port, smart phone, personal data assistant (PDA), tablet computing device, one or more processors within these devices, or any other suitable processing device. The computing device 104, the network management system 110, and the output reporting system 112, respectively include interface(s) 116B, 116C, 116D, processor(s) 118B, 118C, 118D, and memories 114B, 114C, 114D.

The computing device 104 and the output reporting system 112, respectively include graphical user interface(s) (GUIs) 126A and 126B. For example, the GUIs 126A, 126B include an input device, such as a keypad, touch screen, or other device that can accept user information, and an output device that conveys information associated with the operation of the server system 102, or the client device itself, including a display of the material maps and action plan operations selected based on the material movement patterns. The GUIs 126A, 126B each interface with at least a portion of the example system 100 for any suitable purpose, including generating a visual representation of the multispectral images collected by the data collection system 106, the material maps generated by the server system 102, or data stored by the server system 102, such as multispectral images 122 and action plans 124, respectively. In particular, the GUIs 126A, 126B may each be used to view and adjust various action plans. Generally, the GUIs 126A, 126B each provide the user with an efficient and user-friendly presentation of the material maps and action plans including material movement patterns communicated within the example system 100. The GUIs 126A, 126B may each include multiple customizable frames or views having interactive fields, for selection of regions of interest and/or display of material maps for different regions and time points. The GUIs 126A, 126B can each be any suitable graphical user interface, such as a combination of a generic web browser, intelligent engine, and command line interface (CLI) that processes information and efficiently presents the results to the user visually.

The output reporting system 112 can include a reporting engine 120C, the GUI 126B (dashboard), an interface 116D, and a processor 118D. The reporting engine 120C utilizes the analytics data provided by the action plan engine 120B to produce executive and semi executive level displays for the GUI 126B. The GUI 126B displays a high-level summary of a material map assessment, which provides support for material movement patterns in addition to key recommended actions for environment and industrial plant safety and continuous operability. The GUI 126B display can facilitate material distribution monitoring and decision makers to modify (operations of) the systems and machines selected for cleaning identified materials.

The data collection system 106 can include multiple imaging sensors 130A and a detection system 130B. The imaging sensors 130A can be within an aerial device 128 (e.g., attached to or included in the aerial device), acquiring samples and data during a flight or hovering operation. The imaging sensors 130A and the detection system 130B can include any of a hyperspectral sensor, spectroradiometers (e.g., ultraviolet/visible/near infrared/short wave infrared spectroradiometers), a camera, and other types of probes. The processor 118E of the data collection system 106 controls operation of the imaging sensors 130A and the detection system 130B and directs collected and determined data to the server system 102 for storage, further analysis, and modelling. The imaging sensors 130A and the detection system 130B can collect multispectral images of one or more areas of interest below the aerial device 128. Further details about the imaging sensors 130A and the detection system 130B and their operation are provided with reference to FIG. 1B.

In some implementations, the network 108 can include a large computer network, such as a local area network, a wide area network, the Internet, a cellular network, a telephone network, or any appropriate combination thereof connecting any number of communication devices, mobile computing devices, fixed computing devices and server systems. Data exchanged over the network 108, is transferred using any number of network layer protocols, such as Internet Protocol, Multiprotocol Label Switching, Asynchronous Transfer Mode, Frame Relay, etc. Furthermore, in implementations where the network 108 represents a combination of multiple sub-networks, different network layer protocols are used at each of the underlying sub-networks. In some implementations, the network 108 represents one or more interconnected internetworks, such as the public Internet.

Each processor 118A, 118B, 118C, 118D, 118E included in different components of the example system 100 can include a central processing unit, an application particular integrated circuit, a field-programmable gate array, or another suitable component. Generally, each processor 118A, 118B, 118C, 118D, 118E executes instructions and manipulates data for material classification. Each processor 118A, 118B, 118C, 118D, 118E executes a functionality required to monitor multispectral images associated to an aerial device 128, to monitor and correct material movement patterns.

Interfaces 116A, 116B, 116C, 116D, 116E are used by different components of the example system 100 for communicating with other component systems in a distributed environment—including within the example system 100—connected to the network 108. Generally, the interfaces 116A, 116B, 116C, 116D, 116E each include logic encoded in software and/or hardware in a suitable combination and operable to communicate with the network 108. More specifically, the interfaces 116A, 116B, 116C, 116D, 116E may each include software supporting one or more communication protocols associated with communications such that the network 108 or interface's hardware is operable to communicate physical signals within and outside of the illustrated system 100.

The memory 1114A, 114B, 114C, 114D may include any type of memory or database module and may take the form of volatile and/or non-volatile memory including, without limitation, magnetic media, optical media, random access memory, read-only memory, removable media, or any other suitable local or remote memory component. The memory 1114A, 114B, 114C, 114D may store various objects or data, including caches, classes, frameworks, applications, backup data, business objects, jobs, web pages, web page templates, database tables, database queries, repositories storing images 122 (e.g., multispectral images and/or dynamic information, and any other appropriate information including material movement pattern models, and any material cleaning parameters, variables, algorithms, instructions, rules, constraints, or references thereto) associated with the purposes of the server system 102, the computing device 104, the data collection system 106, the network management system 110, and the output reporting system 112, respectively.

There may be any number of computing devices 104 and data collection systems 106 associated with, or external to, the example system 100. Additionally, there may also be one or more additional client devices external to the illustrated portion of system 100 that are configured for interacting with the example system 100 via the network(s) 108. Further, the term “client,” “client device,” and “user” may be used interchangeably as appropriate without departing from the scope of the disclosure. Moreover, while client device may be described in terms of being used by a single user, the disclosure contemplates that many users may use one computer, or that one user may use multiple computers. As used in the present disclosure, the term “computer” is intended to encompass any suitable processing device. For example, although FIG. 1A illustrates a single server system 102, a single computing device 104, a single data collection system 106, a single network management system 110, the example system 100 can be implemented using a single, stand-alone computing device, two or more core systems 102, or multiple client devices. The server system 102, the computing device 104 and the output reporting system 112 may include any computer or processing device such as, for example, a blade server, general-purpose personal computer, workstation, or any other suitable device. In other words, the present disclosure contemplates computers other than general purpose computers, as well as computers without conventional operating systems. Further, the server system 102 and the computing device 104 and the output reporting system 112 may be adapted to execute any operating system or runtime environment. According to one implementation, the server system 102 may also include or be communicably coupled with an e-mail server, a Web server, a caching server, a streaming data server, and/or another suitable server, as described with reference to FIG. 1B.

FIG. 1B is a block diagram of a portion of the example system 100 that can be used to execute implementations of the present disclosure. In particular, FIG. 1B depicts a schematic diagram illustrating an example portion 101 of a variation of the example system 100 described with reference to FIG. 1A, in accordance with some example embodiments. The example portion 101 of the example system 100 illustrated in FIG. 1B includes the data collection system 106, a detection and classification system 120A, and an output reporting system 112.

The data collection system 106 includes imaging sensors 130A, a data collection system 130B, and an image preprocessing system 130C. The imaging sensors 130A can be coupled to the aerial device 128 and can be displaced to capture multispectral images of multiple regions of interest. The imaging sensors 130A and the detection system 130B are communicatively connected to the processor 118E. The imaging sensors 130A can include red green blue (RGB) imaging devices, multispectral sensors, and hyperspectral sensors (e.g., infrared imaging spectrometers), or other imaging systems facilitating the collection of multispectral images. The data collection system 130B can generate triggers according to a particular schedule to control data collection executed by the imaging sensors 130A. The data collection system 130B can receive the multispectral images collected by the imaging sensors 130A and transmit them to the image preprocessing system 130C for pre-processing.

The image preprocessing system 130C executes pre-processing of multispectral images that can enhance data quality and can ensure accurate downstream analysis. Pre-processing can include: noise correction to remove sensor noise using correction coefficients during image processing; vignetting correction to address uneven illumination across the image caused by lens vignetting; lens distortion correction to apply distortion models (such as the brown model) to correct lens-induced distortions; band registration to align spectral bands to ensure consistent spatial information; and radiometric correction to normalize pixel values to account for variations in sensor sensitivity. For UAV-based multispectral sensors, these steps optimize data quality, enabling accurate material monitoring and other applications.

The detection and classification system 120A includes a filtering engine 132A, a Euclidian minimum spanning tree engine 132B, and an artificial intelligence (AI) model classification system 132C. The filtering engine 132A applies any of a multidimensional edge detection filter, a multidimensional 9-point Laplacian filter and can generate a volatility map and a locally normalized edge index. The Euclidian minimum spanning tree engine 132B can determine a Euclidian minimum spanning tree of unmasked samples and can generate a dendrogram of pure materials. The AI model classification system 132C can process multiple maps of materials of a particular region, corresponding to multiple time points to generate material variation patterns. The AI model classification system 132C can include machine learning techniques (e.g., neural networks) trained to analyze spatial data and reveal patterns over time.

The output reporting system 112 includes an automatic risk assessment system 134A, an output data system 134B, an action triggering system 134C, and a machine 134D. The automatic risk assessment system 134A can process the material variation patterns and most recently generated maps of materials to determine risks associated to one or more points of interests (e.g., roads, industrial plants, oil drilling and processing systems, etc.). The output data system 134B can include a GUI (e.g., GUI 126 described with reference to FIG. 1A) to generate displays indicating the identified risk. The action triggering system 134C can receive the determined risk, classify the risk (e.g., low, medium, or high) and, based on the classification, generate a trigger to send to the machine 134D to perform a remedial action (e.g., cleaning or relocation of material within the region of interest to protect the one or more points of reference).

While portions of the example system 100 illustrated in FIGS. 1A and 1B are shown as individual modules that implement the various features and functionality through various objects, methods, or other processes, the hardware components can execute software that can include multiple sub-modules, third-party services, components, libraries, and such, as appropriate. Conversely, the features and functionality of various components can be combined into single components as appropriate.

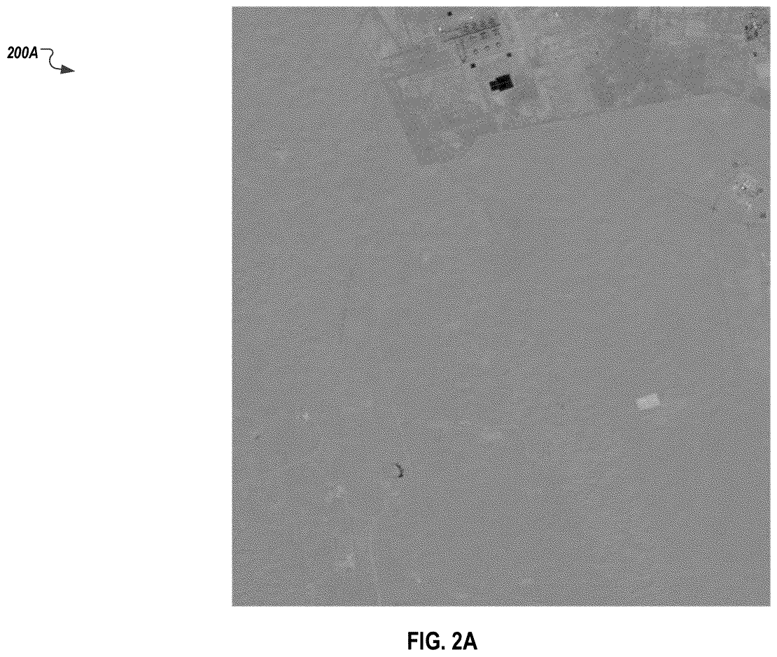

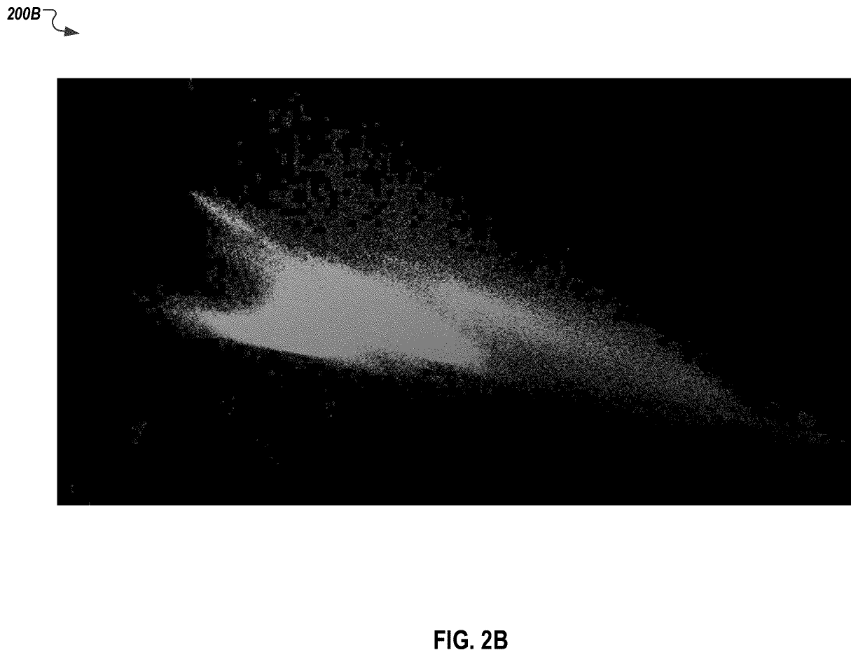

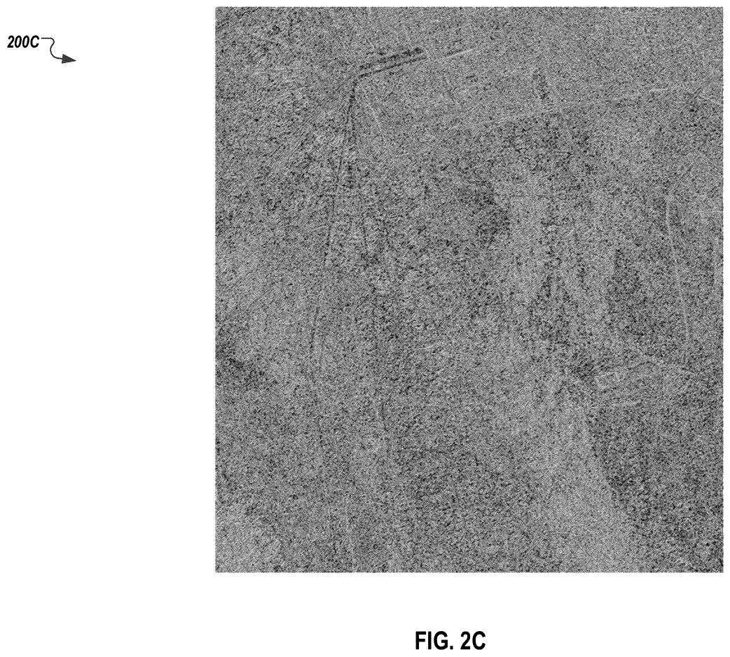

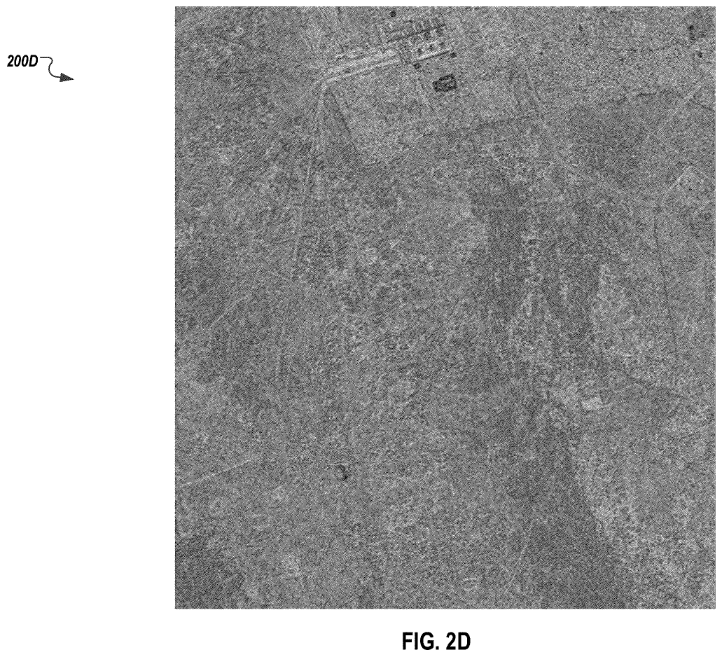

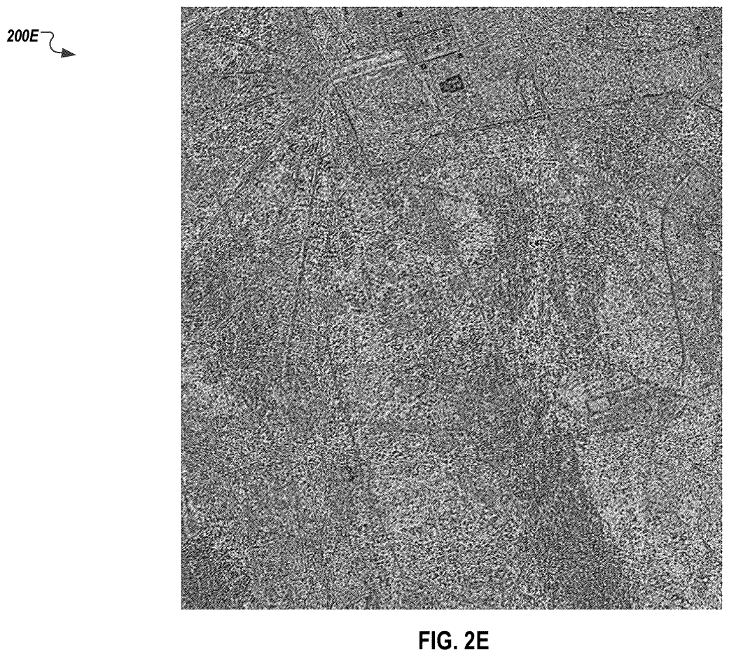

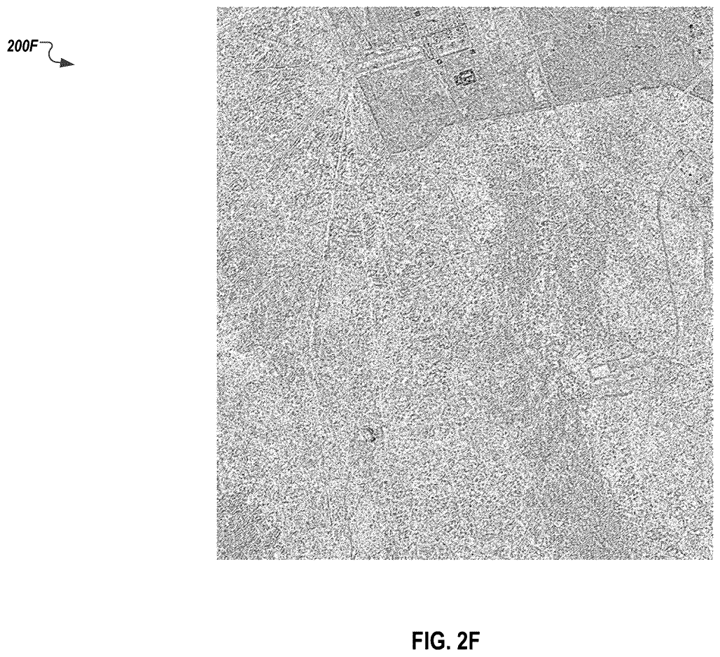

FIG. 2A illustrates an example of a multi- or hyperspectral image 200A, according to some implementations of the present disclosure. The example of a multi- or hyperspectral image 200A can have N=W*H pixels (with width W and height H), with each pixel having an associated spectrum consisting of C “channels” (or “bands”, or “dimensions”). For example, the example of a multi- or hyperspectral image 200A has 1,262×1,533=1,934,646 pixels with 12 bands. The example of a multi- or hyperspectral image 200A can be captured by multispectral sensors that generate data in a few wavelength bands (e.g., 3 to 10 bands), such as red, green, blue, near infrared, and short-wave infrared. The bands can have descriptive titles and a spatial resolution of 30 meters (except for a few particular bands). The example of a multi- or hyperspectral image 200A can help identify land cover, vegetation health, oil spills, sand encroachment, and water quality. The example of a multi- or hyperspectral image 200A can include hyperspectral imagery to provide detailed spectral information, facilitating identification of particular materials and respective unique signatures.

FIG. 2B illustrates example 2-dimensional scatterplot 200B of the first two principal components of the 12-dimensional spectra from image in FIG. 2A, according to some implementations of the present disclosure. The example 2-dimensional scatterplot 200B can include a set of spectra associated with the pixels that can be represented as vectors in a 12-dimensional space, where materials with similar spectra can form clusters of high density. Every point in the example 12-dimensional scatterplot 200B can correspond to the spectrum of a vector associated with a pixel in the example of a multi- or hyperspectral image 200A, described with reference to FIG. 2A.

FIG. 2C illustrates an example combined mixed pixel mask image 200C with a particular edge percentage (e.g., 50%) of edges (shown in yellow) and a particular percentage (e.g., 1%) of subpixel anomalies (shown in in purple) removed, according to some implementations of the present disclosure. The example combined mixed pixel mask image 200C illustrates results of combined mixed pixel mask used to remove mixed pixels which occur both as edges at the border of two or more materials or as subpixel anomalies where a subpixel object distorts the spectrum of the surrounding material in a given pixel.

FIG. 2D illustrates an example of false color image 200D of top 8 clusters, according to some implementations of the present disclosure. The example of false color image 200D can differentiate between elements or compounds corresponding to the top 8 clusters. In space observations, the example of false color image 200D can help identify the distribution of the corresponding elements of the top 8 clusters.

FIG. 2E illustrates example false color image 200E of top 64 clusters, according to some implementations of the present disclosure. The example of false color image 200E can differentiate between elements or compounds corresponding to the top 64 clusters. In space observations, the example of false color image 200E can help identify the distribution of the corresponding elements of the top 64 clusters.

FIG. 2F illustrates example false color image 200F of top 1378 clusters, according to some implementations of the present disclosure. The example of false color image 200F can differentiate between elements or compounds corresponding to the top 1378 clusters. In space observations, the example of false color image 200F can help identify the distribution of the corresponding elements of the top 1378 clusters providing a higher set of information than false color image of smaller numbers of top clusters, as shown in FIGS. 2D and 2E.

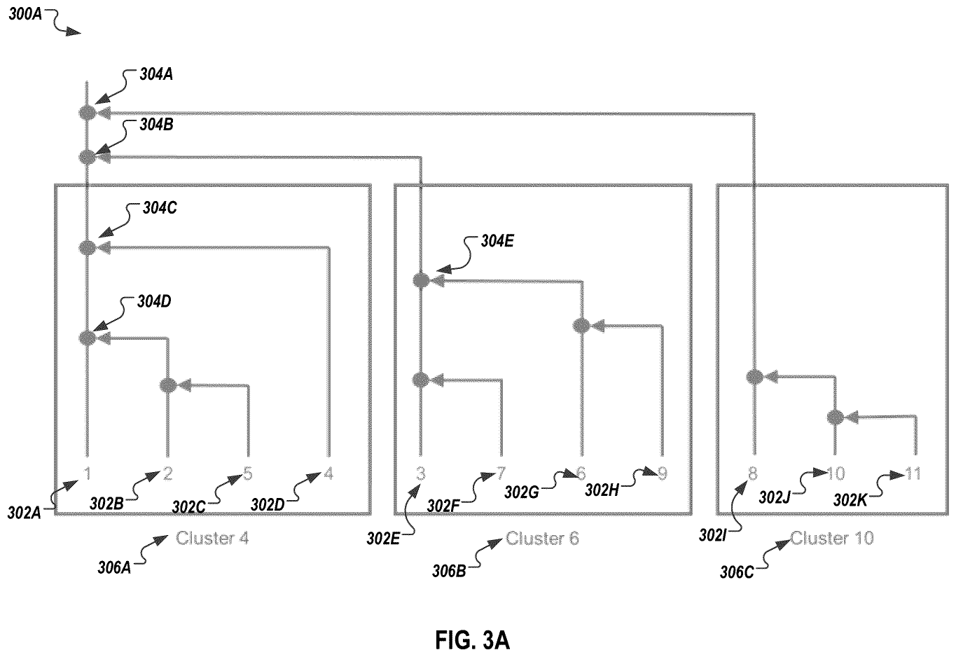

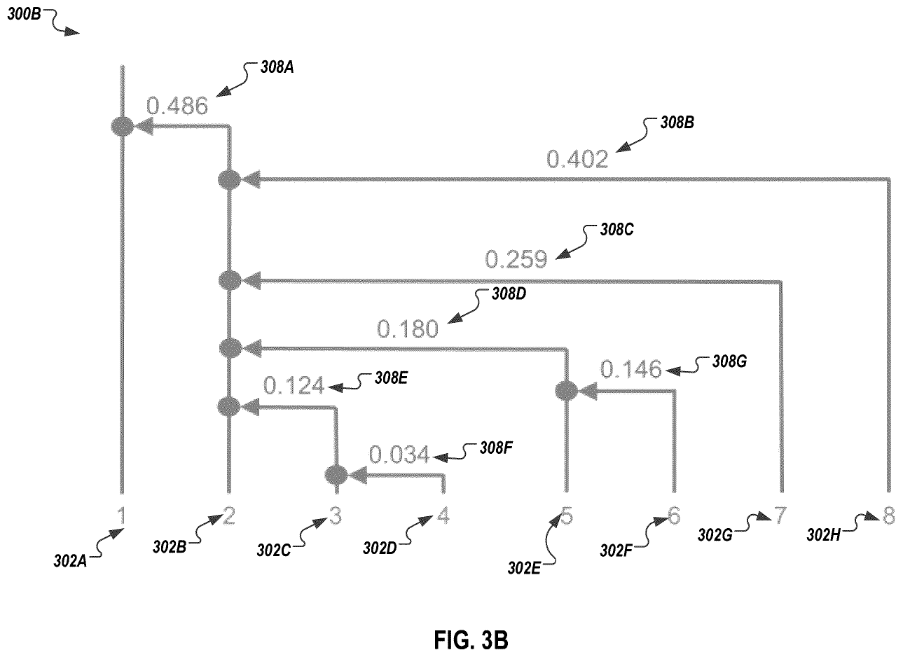

FIG. 3A illustrates an example dendrogram 300A resulting from hierarchical clustering, according to some implementations of the present disclosure. In the example dendrogram 300A each leaf node corresponds to a sample 302A-302K in the original data set, and is encoded in the arrays tree(i) and pix(i). For example, leaf node 3 can correspond to sample 5, such that tree(5)=3 and pix(3)=5. Each non-leaf node in the binary tree corresponds to the cluster 306A, 306B, 306C containing all of the samples (e.g., leaf nodes) 302A-302K beneath it, and is numbered according to the sample that ‘joins’ to it. For example, a node 204E above sample 3 302E in the central box is cluster 6 306B that contains samples 3, 7, 6 and 9, that are joined as join(6)=3 and that clustsize(6)=4. The joining height is stored in height(6). For a cluster 6 that is formed of a cluster 9 merged with cluster 7 an updated cluster is generated such that clust1size(6)=clustsize(7)=2 and clust2size(6)=clustsize(9)=2. In the illustrated example, cluster 8 contains all eleven samples with join(8)=1. The first sample in the dendrogram (in this case sample 1) does not join to any other sample (represented by join(1)=1) and so does not correspond to a cluster. Each leaf node corresponds to a single-sample cluster. The cluster number can be equal to the sample index+N, where N is the total number of samples.

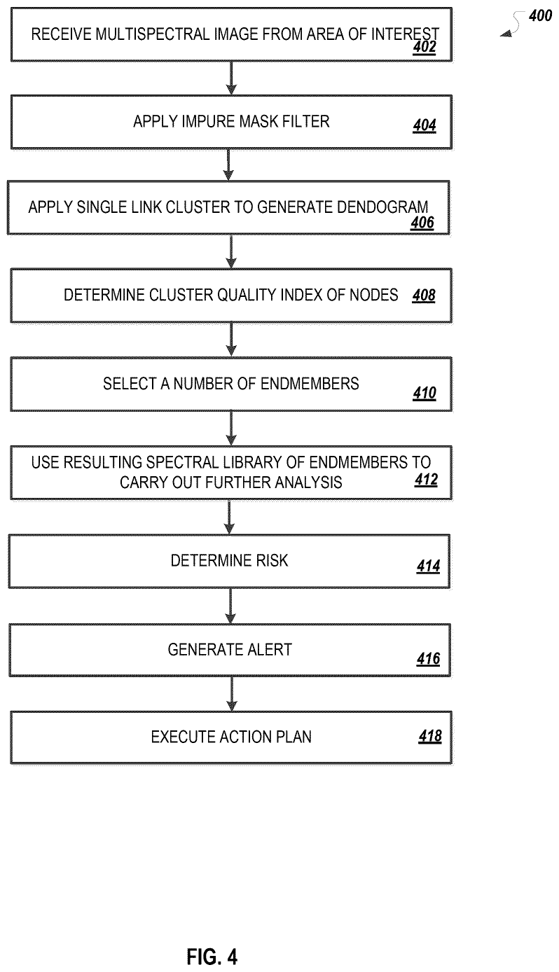

FIG. 3B illustrates an example cluster quality index 300B for a simple dendrogram, according to some implementations of the present disclosure. The example cluster quality index 300B includes eight samples with seven branch nodes corresponding to clusters 2 to 8 which appear in order in the tree. The joining heights 308A-308G represent the cluster merged heights across all dendrogram levels. The calculation of the cluster quality index for each cluster is described in detail with reference to FIG. 4.

FIG. 4 depicts a flowchart illustrating an example process for clustering algorithms for unsupervised segmentation of multispectral images, in accordance with some example embodiments. Referring to FIGS. 1A and 1B, the process 400 can be performed by any components of the example systems 100, 101.

At 402, a multispectral image is received, by one or more processors, from a region of interest. The multispectral image can be received from a satellite, or an aerial device (e.g., aerial device 128 described with reference to FIG. 1A) equipped with a multispectral image acquisition device. A typical multi- or hyperspectral image (e.g., example multispectral image 200A) can have N=W*H pixels (with width W and height H), with each pixel having an associated spectrum consisting of C “channels” (or “bands”, or “dimensions”). The set of spectra associated with the pixels can be represented as vectors in a multi-dimensional (e.g., 12-dimensional) space, where materials with similar spectra can form clusters of high density. The multispectral image can be processed to obtain two or three-dimensional cross sections showing the first two or three principal components of the 12-dimensional spectral vector space. Every point in the scatterplot can corresponds to the spectrum of a vector associated with a pixel in the original multispectral image. The set of spectra associated with the pixels can be represented as a scatterplot including vectors in a 12-dimensional space, where materials with similar spectra can form clusters of high density. Every point in the scatterplot corresponds to the spectrum of a vector associated with a pixel in the original image.

At 404, a multidimensional edge detection filter is applied, by the one or more processors. In order to mask out the “impure” pixels, an edge detection filter is first applied. Applying the edge detection filter can include a convolution with a 3×3 edge detection filter for detecting edges in grayscale images. The application of the edge detection filter can effectively measure the gradients Gₓ and G_{y} in the x- and y-directions respectively at each pixel, with the overall gradient measure for the pixel given by:

$$G = \sqrt{{G}_{x}^{2} + {G}_{y}^{2}}$$

The edge detection filter can be applied to a grayscale conversion of the multispectral image. The edge detection filter can include a Sobel filter or a Scharr filter. The 3×3 Scharr filter has a better rotational invariance than the Sobel filter. The Scharr filter can be the basis of the normalized multidimensional edge detection filter: The form of the Scharr filter for measurement of gradients in the x-direction is:

$${h}_{x}^{′} ( : , : ) = [ \begin{matrix}- 47 & 0 & 47 \\ - 162 & 0 & 162 \\ - 47 & 0 & 47\end{matrix} ]$$

The negative transpose of the filter is the Scharr filter in the y-direction. In order to apply Scharr filter to multi- and hyperspectral images, the x- and y-direction filters are both extended into a cuboid of length equal to the number D of bands in the image (e.g., 12 bands). Each 3×3 layer of the 3×3×D filters that result can contain the same values as above. In order for the resulting filter to be applied to the edge and corner pixels, linear interpolation can be used to extend the image by one pixel at the edges and corners for the top left corner of one band of the image. The linear interpolation can be done for all of the edge and corner pixels in all of the bands. Add a border around each band of the image by linearly interpolating the values by one pixel. The x- and y-direction Scharr filters can be applied band-by-band and pixel-by-pixel to the entire image to obtain G_{x[k]} and G_{y[k]} for each pixel where k denotes the band. For example, the formula for calculating G_{x[k]} by applying Gₓ to pixel (i,j) in band k of the image (where “I” is the x-coordinate “j” is the y-coordinate) is given by:

$${G}_{x [ k ]} = 47. * ( v [ i ] [ j ] [ k ] + v [ i ] [ j + 2 ] [ k ] - v [ i + 2 ] [ j ] [ k ] - v [ i + 2 ] [ j + 2 ] [ k ] ) + 162. * ( v [ i ] [ j + 1 ] [ k ] - v [ i + 2 ] [ j + 1 ] [ k ] ) ,$$

The term v[i][j][k] is the value of the pixel (i,j) in band k. The strength of the edge for a given pixels is then the square root of the sum over all bands of G_{x[k]}*G_{x[k]}+G_{y[k]}*G_{y[k]}. This can also be represented as a matrix convolution. The term G_{y[k]} is calculated for the pixel in band k in the same way, and the set of G_{x[k]} and G_{y[k]} over all bands is used to calculate the edge index G for the pixel (e.g., FIG. 2C shows the result of calculating the edge index for all pixels in the image). The process of masking out mixed pixels reduces the original S data samples/pixels to a portion (N) of samples that remain unmasked.

At 406, a single-link clustering is applied to the filtered pixels to generate a dendrogram. For applying the single-link clustering, a Euclidean minimum spanning tree of unmasked samples is determined. The Euclidean minimum spanning tree (EMST) of the data samples can be calculated using a single-link clustering, a dendrogram, which includes a binary tree encoding the hierarchy of clusters of the spectra in the image. The dendrogram is built up one branch at a time such that each pixel's spectrum is initially considered to belong to its own cluster. The “closest” two clusters are merged into a single cluster with the merging height or “join” height being the distance between them. In the case of single-link clustering, the distance between two clusters is the shortest distance between two points, one from each cluster. Other standard hierarchical clustering methods differ only in the way that the distance between clusters is measured. The merging process is repeated until only a single cluster remains. The result of single-link clustering can be encoded in a dendrogram. Determining the Euclidean minimum spanning tree of unmasked can include rotating, ranking, and reordering data samples of the dendrogram, creating leaf nodes, generating records, and identifying clusters for merging.

The dendrogram (or “binary tree” or simply “tree”) resulting from the hierarchical clustering of N samples has 2N−1 nodes, including N leaf nodes and N−1 branch nodes (as shown in FIG. 3A). Each leaf node corresponds to a sample in the original data set, and is encoded in the arrays tree(i) and pix(i). Each non-leaf node in the binary tree corresponds to the cluster containing all of the samples (e.g., leaf nodes) beneath it, and is numbered according to the sample that ‘joins’ to it. The results of the clustering procedure can be saved in the following arrays: tree(i)—the position in the dendrogram of the leaf node/tree position corresponding to the i-th data sample; pix(i)—the index of the data sample corresponding to the i-th leaf node/tree position in the dendrogram; join(i)—the data sample to which a sample i “joins” in the tree; height(i)—the joining height with which data sample i joins to data sample join(i) in the tree; source(i), destination(i)—when cluster j merges with cluster k to form cluster i in the tree, such as closest two samples, the first from cluster j and the second from cluster k; clustsize(i)—the size of cluster i in the tree; clust1size(i), clust2size(i)—when cluster j merges with cluster k to form cluster i in the tree. The sizes of cluster k and cluster j respectively, with cluster k can be on the left and cluster j on the right. Each node in the dendrogram corresponds to a cluster. The resulting dendrogram can include millions of clusters.

At 408, a cluster quality index of nodes is determined for selection of a subset of clusters from the dendrogram. The cluster quality index of nodes defines a quality of the clusters to be quantified with a measure that matches historical quantification of clusters. In some implementations, clusters are considered intuitively to be significant or important under two conditions: 1) whenever two large clusters merge to form a larger one, where such clusters correspond to the “core” materials or clusters; and 2) whenever two clusters merge such that the inter-cluster joining height is much larger than the intra-cluster joining height—that can typically correspond to cases of anomalous or unusual or interesting or rare materials or clusters. For each of the N−1 non-leaf clusters (e.g., excluding the first sample in the dendrogram), two different measures can be introduced. The measures include a “size quality index” (SQI), sizequal(i) and a “height quality index” (HQI), heightqual(i). The SQI of a cluster is defined to be the sum of the logs of the sizes of both itself and the cluster it merges with. The SQI value is maximized when the merged clusters are both large and also similar in size. The HQI is the log of the ratio of its “merging height” to its “height of formation”, e.g., the ratio of the height at which it merges to form the next largest cluster to the height at which its two child clusters merged when the cluster itself was formed. An example algorithm for calculating SQI and HQI is provided as follows:

```
  Initialize sizequal and meightqual as vectors of size N−1.
  Set logheightratio to 0.0.
  For each i from 2 to N (ignoring the first leaf node):
    Set nextclust to the result of getNextCluster(i).
    If nextclust is less than N+1:
      Set sizequal[i − 1] to the sum of log(clust1size[nextclust]) and
log(clust2size[nextclust]).
    Else:
      Set sizequal[i − 1] to 0.0.
    If height[i] is less than or equal to 0.0:
      Set logheightratio to 0.0.
    Else:
      Set logheightratio to the difference between log(getNextHeight(i)) and
log(height[i]).
    Set heightqual[i − 1] to logheightratio.
  The function getNextCluster( ) to get the next largest cluster containing a given
cluster is defined as follows:
  Function getNextCluster(clust):
    If clust is greater than or equal to N+1: (single-point cluster)
      Set i to clust − N.
      Set h to height[i].
      If i is less than N and join[i + 1] is equal to i:
        Return i + 1.
      Else:
        Return i.
    Else if clust is between 1 and N (inclusive):
      Set j to join[clust].
      Set h to height[clust].
      Set i to j + clustsize[clust].
      If i is greater than or equal to N+1:
        If j is greater than 1:
          Return j.
        Else:
          Return clust (already at top cluster).
      Else if join[i] is equal to j:
        Return i.
      Else:
        Return j.
    Else:
      Return clust (invalid cluster, return unchanged).
  The function getNextHeight() to get the next joining height of a cluster is defined
as follows:
  Function getNextHeight(clust):
    If clust is greater than or equal to N+1: (single-point cluster)
      Set i to clust - N.
      Set h to height[i].
      If join[i + 1] is equal to i:
        Return height[i + 1].
      Else:
        Return height[i].
    Else:
      Set j to join[clust].
      Set h to height[clust].
      Set i to j + clustsize[clust].
      If i is greater than or equal to N+1:
        Return h.
      Else if join[i] is equal to j:
        Return height[i].
      Else:
        Return height[j].
```

The cluster that includes all the samples is a special case as it does not merge with any other clusters (e.g., both the size of the cluster it merges with and the height of merging to be infinite), such that both the SQI and HQI can be determined as being infinite for the corresponding cluster. The “cluster quality index” (CQI), clustqual(i), of each cluster can now be defined as the following linear sum of the size quality index and the height quality index of that cluster:

$$CQI = SQI + α * HQI$$

The coefficient α can be varied depending upon the relative importance of the two quality indices for a give context. Its value can be decreased if the user is more interested in the bulk or core clusters, and can be increased if the user is more interested in looking for unusual clusters or anomalies. The default value of α=2.0 can be used to result in a good balance of intuitively selected clusters of both kinds. Note that the cluster containing all the samples can automatically have an infinite CQI and can be a significant cluster and also the first cluster to be selected. The method for calculating the CQI clustqual(i) for all N−1 non-leaf clusters can include initialization of clustqual as a vector of size N−1 to measure the significance of each non-leaf cluster. For each index i from 2 to N (ignoring the first leaf node), clustqual[i−1] can be set to the sum of sizequal[i−1] and alpha multiplied by heightqual[i−1]. An example Calculation of the SQI, HQI and CQI of the non-leaf clusters is shown in Table 1.

TABLE 1

| | Merge | Paret | Clust1 | Clust2 | | Form. | Join | | |
|---|---|---|---|---|---|---|---|---|---|
| Cluster | with | cluster | size | size | SQI | height | height | HQI | CQI |
| 2 | — | — | MAX | 8 | MAX | 0.486 | MAX | MAX | MAX |
| 3 | 6 | 5 | 3 | 2 | 1.792 | 0.124 | 0.180 | 0.373 | 2.537 |
| 4 | 10 | 3 | 1 | 2 | 0.693 | 0.034 | 0.124 | 1.294 | 3.281 |
| 5 | 15 | 7 | 5 | 1 | 1.609 | 0.180 | 0.259 | 0.364 | 2.337 |
| 6 | 3 | 5 | 3 | 2 | 1.792 | 0.146 | 0.180 | 0.209 | 2.210 |
| 7 | 16 | 8 | 6 | 1 | 1.792 | 0.259 | 0.402 | 0.440 | 2.671 |
| 8 | 9 | 2 | 1 | 7 | 1.946 | 0.402 | 0.486 | 0.190 | 2.325 |

At 410, a number of endmembers is selected by analyzing how a number of selected clusters grows with a number of samples and hence as the size of the dendrogram increases. Intuitively, it makes sense that the density of selected clusters (considered in terms of the number of nodes in the dendrogram) can remain constant as the dendrogram grows larger. In terms of size, the physical area of the dendrogram grows as O(N²), whereas the number of clusters grows as O(N), such that the number of clusters selected can grow as O(sqrt(N)). For small data sets, for example, with 5 samples, 4 clusters (including the cluster containing all the samples by default) can be selected. As another example, for 8 samples, 4 clusters can be selected, for 20 samples, approximately 7 clusters can be selected. For unsupervised analyses carried out by one or more processors, the reference library of clusters (or spectral library of “endmembers”/materials in the case of multi- or hyperspectral images) can be determined by the following formula, which generally guarantees a sensible number of clusters for any size of data set and also has the desired scaling property as the number of samples increases:

$$Default number of reference clusters = ceil ( sqrt ( 2 N - 1 ) )$$

The formula for selecting the number of endmembers can be efficient for many different types and sizes of dataset. For example, where there are just over 950,000 unmasked pixels, the ideal number of reference materials/endmembers can be slightly less than 1400. Once the number of reference clusters R has been chosen, the CQIs of the clusters are ranked in descending order from highest to lowest and the top R clusters with highest CQI value are added to the main cluster reference library (or the endmember spectral library for images). For applications where visual interpretation of the results is included in the example process 400, a relatively small number of clusters, typically less than 100, can be selected irrespective of the size of the image or data set. Because of the power of the cluster quality index, the selected number of clusters can also be adjusted based on historical matching of previous reviewed and approved numbers of clusters per sample size.

At 412, resulting spectral library of endmembers is used to carry out further analysis. In satellite remote sensing applications, the spectral library of key endmembers can be used to carry out a wide range of further analyses and tasks, such as spectral unmixing, image segmentation, materials mapping, anomaly detection and change monitoring and indeed can be applied wherever multispectral and hyperspectral remote sensing image processing is used. In practical applications, one or more of the following additional steps can be included to make use of the signal output from the described approach. Statistical models can be built of the clusters of interest. The statistical models can be used directly for material classification or anomaly detection, for example. Spectral unmixing can be applied to calculate the precise materials composition of the impure pixels, or any other spectra from images containing similar materials to the original image. Spectral unmixing can be used to identify anomalous or subpixel materials, or to constrain their spectra which can then be compared with a reference library of materials/endmembers. In particular, the reference library of materials/endmembers can be used to detect and estimate the abundance of trace materials such as greenhouse gas emissions or pollutants whose spectra are known. Maps of material abundance over an image or region can be generated by applying spectral unmixing to the original image or other images in that region. Changes in the material abundance in temporally separated images of the same region can be used for change detection, monitoring and object/materials tracking. The above can be applied to scan large regions either domestically or globally for large scale mapping, intelligence and reconnaissance.

At 414, a risk is determined, by the one or more processors. The risk can be determined by performing a temporal variation of materials over the region of interest. For example, changes in the material abundance in temporally separated images of the same region can be used for change detection, monitoring and object/materials tracking and material variation patterns. The temporal variation analysis can be applied to scan large regions either domestically or globally for large scale mapping, safety, and security.

At 416, an action plan defining an action and a corresponding surface equipment is determined, by the one or more processors. The action plan can be identified by machine learning models (e.g., recurrent neural networks with a multi-layer network topology) trained and fine-tuned to generate an automatic selection of an efficient remedial action (e.g., activation of one or more cleaning machines or deactivation of one or more systems for safety and protection of an environment and an industrial plant). The surface equipment can be selected to match the characteristics of the material movement pattern and execute the intended material cleaning or removal operations. The trained machine learning models can be configured to operate in active mode, for material movement pattern identification, facilitating automatic action plan implementation. For example, the trained machine learning models can trigger an initiation of the action plan, and a modification of surface equipment operations based on most recent map of materials relative to the predicted material movement pattern.

At 418, the action plan is automatically executed by generating a trigger, by the one or more processors, to activate an operation of a system or a machine configured to perform a remedy operation (e.g., cleaning, filtering, or material removal operation).

The example process 400 facilitates optimization of accurate generation of material map. One of the greatest benefits of generation of an accurate material map is that it facilitates activation of automatic remedial machine actions to ensure continuous workflows and access to facilities. The example process 400 enhances a characterization of regions of interest, providing resource conservation opportunities by minimizing computing system requirements and optimization of monitorization of a large range of materials.

In some implementations, customized user interfaces can present intermediate or final results of the above-described processes on a user interface of a user device. Information can be presented in one or more textual, tabular, or graphical formats, such as through a dashboard. The information can be presented at one or more on-site locations (such as at an oil well or other facility), on the Internet (such as on a webpage), on a mobile application (or “app”), or at a central processing facility. The presented information can include suggestions, such as suggested changes in parameters or processing inputs, that the user can select to implement improvements in a production environment, such as in the exploration, production, and/or testing of petrochemical processes or facilities. For example, the suggestions can include parameters that, when selected by the user, can cause a change to, or an improvement in, material management associated with overall production of a gas or oil well. The suggestions, when implemented by the user, can improve the speed and accuracy of calculations, streamline processes, improve models, and solve problems related to efficiency, performance, safety, reliability, costs, downtime, and the need for human interaction. In some implementations, the suggestions can be implemented in real-time, such as to provide an immediate or near-immediate change in operations or in a model. The term real-time can correspond, for example, to events that occur within a specified period-of-time, such as within one minute or within one second. Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. The described technology can be especially useful for systems or various pieces of equipment that are located several meters or several miles apart or are located in different countries or other jurisdictions.

In some implementations, the process 400 described with reference to FIG. 4 can include a cluster selection algorithm can optionally be applied to generate a library of key reference clusters or endmembers. Statistical models can be built of the clusters of interest. The clusters of interest can be used directly for materials classification or anomaly detection for example. Spectral unmixing can be applied to calculate the precise materials composition of the impure pixels, or any other spectra from images containing similar materials to the original image. Spectral unmixing can be used to identify anomalous or subpixel materials, or to constrain their spectra which can then be compared with a reference library of materials/endmembers. In particular, spectral unmixing can be used to detect and estimate the abundance of trace materials such as greenhouse gas emissions or pollutants whose spectra are known. Maps of material abundance over an image or region can be generated by applying spectral unmixing to the original image or other images in that region. Changes in the material abundance in temporally separated images of the same region can be used for change detection, monitoring and object/materials tracking. The temporal material differences can be applied to identify material movement patterns throughout large regions either domestically or globally for large scale mapping, intelligence and reconnaissance.

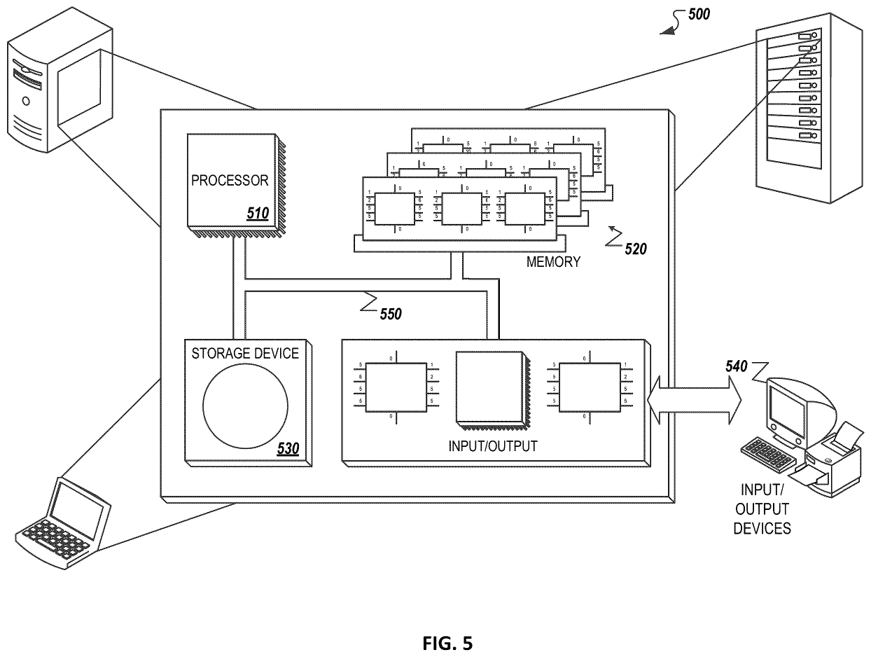

FIG. 5 depicts a block diagram illustrating a computing system 500, in accordance with some example embodiments. Referring to FIGS. 1A and 1B, the computing system 500 can be used to implement the server system 102 and/or any other components of the example system 100.

As shown in FIG. 5, the computing system 500 can include a processor 510, a memory 520, a storage device 530, and input/output devices 540. The processor 510, the memory 520, the storage device 530, and the input/output devices 540 can be interconnected using a system bus 550. The processor 510 is capable of processing instructions for execution within the computing system 500. Such executed instructions can implement one or more components of, for example, the example system 100. In some implementations of the current subject matter, the processor 510 can be a single-threaded processor. Alternately, the processor 510 can be a multi-threaded processor. The processor 510 is capable of processing instructions stored in the memory 520 and/or on the storage device 530 to display graphical information for a user interface provided using the input/output device 540.

The memory 520 is a computer readable medium such as volatile or non-volatile that stores information within the computing system 500. The memory 520 can store data structures representing configuration object databases, for example. The storage device 530 is capable of providing persistent storage for the computing system 500. The storage device 530 can be a floppy disk device, a hard disk device, an optical disk device, or a tape device, or other suitable persistent storage means. The input/output device 540 provides input/output operations for the computing system 500. In some implementations of the current subject matter, the input/output device 540 includes a keyboard and/or pointing device. In various implementations, the input/output device 540 includes a display unit for displaying graphical user interfaces.

According to some implementations of the current subject matter, the input/output device 540 can provide input/output operations for a network device. For example, the input/output device 540 can include Ethernet ports or other networking ports to communicate with one or more wired and/or wireless networks (e.g., a local area network (LAN), a wide area network (WAN), the Internet).

In some implementations of the current subject matter, the computing system 500 can be used to execute various interactive computer software applications that can be used for organization, analysis and/or storage of data in various (e.g., tabular) format (e.g., Microsoft Excel®, and/or any other type of software). Alternatively, the computing system 500 can be used to execute any type of software applications. These applications can be used to perform various functionalities, e.g., planning functionalities (e.g., generating, managing, editing of spreadsheet documents, word processing documents, and/or any other objects), computing functionalities, or communications functionalities. The applications can include various add-in functionalities or can be standalone computing products and/or functionalities. Upon activation within the applications, the functionalities can be used to generate the user interface provided using the input/output device 540. The user interface can be generated and presented to a user by the computing system 500 (e.g., on a computer screen monitor).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random-access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The preceding figures and accompanying description illustrate example processes and computer implementable techniques. The environments and systems described above (or their software or other components) may contemplate using, implementing, or executing any suitable technique for performing these and other tasks. It can be understood that these processes are for illustration purposes only and that the described or similar techniques may be performed at any appropriate time, including concurrently, individually, in parallel, and/or in combination. In addition, many of the operations in these processes may take place simultaneously, concurrently, in parallel, and/or in different orders than as shown. Moreover, processes may have additional operations, fewer operations, and/or different operations, so long as the methods remain appropriate.

In other words, although the disclosure has been described in terms of certain implementations and generally associated methods, alterations and permutations of these implementations, and methods will be apparent to those skilled in the art. Accordingly, the above description of example implementations does not define or constrain the disclosure. Other changes, substitutions, and alterations are also possible without departing from the spirit and scope of the disclosure.

A number of implementations of the present disclosure have been described. Nevertheless, it will be understood that various modifications may be made without departing from the spirit and scope of the present disclosure. Accordingly, other implementations are within the scope of the following claims.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application.

Example 1. A computer-implemented method comprising: receiving a multispectral image corresponding to a region of interest, the multispectral image comprising aerial images of the region of interest captured by a multispectral sensor, the multispectral image comprises a plurality of pixels; processing the multispectral image, by applying a multidimensional edge detection filter to remove a portion of the plurality of pixels identified as impure pixels, a remaining portion of plurality of pixels comprising unmasked samples; determine a Euclidian minimum spanning tree of unmasked samples, wherein the unmasked samples are rotated to minimize a dimension of the unmasked samples; applying a single-link clustering to generate a dendrogram of pure materials; determining a cluster quality index for each cluster to sort the pure materials in order of significance and to select a portion of the pure materials as key materials based on the order of significance; applying a spectral unmixing procedure to generate a map of the key materials in the multispectral image; and identifying an action plan to remedy a risk associated with the map of key materials.

Example 2. The computer-implemented method of the preceding example, wherein each pixel of the plurality of pixels having an associated spectrum consisting of a plurality of dimensions.

Example 3. The computer-implemented method of any of the preceding examples, wherein applying the multidimensional edge detection filter comprises: locally normalizing edges and subpixel anomalies within the multispectral image using a volatility map; and applying an edge filter mask to remove a portion of the edges and an anomaly filter mask to remove a portion of the subpixel anomalies to generate a map of pure pixels which remain unmasked.

Example 4. The computer-implemented method of any of the preceding examples, wherein applying the single-link clustering comprises: applying a hierarchical clustering algorithm to the map of pure pixels to generate a dendrogram comprising the clusters of pure materials.

Example 5. The computer-implemented method of any of the preceding examples, wherein identifying and selecting the key materials comprises: calculating a size quality index and a height quality index for each non-leaf cluster in the dendrogram; combining the size quality index and the height quality index to calculate an overall cluster quality index for each cluster; sorting the clusters in descending order of cluster quality index to generate sorted clusters; and selecting a portion of the sorted clusters as the key materials or endmembers used for subsequent processing.

Example 6. The computer-implemented method of any of the preceding examples, wherein a spectral unmixing procedure is applied to generate a map of key materials in the multispectral image.

Example 7. The computer-implemented method of any of the preceding examples, further comprising comparing to the map of materials to a past map of materials to determine a material change pattern.

Example 8. The computer-implemented method of any of the preceding examples, wherein identifying the action plan comprises: determining a risk associated with the material change pattern; and

generating an alert indicative of the risk associated with the material change pattern.

Example 9. The computer-implemented method of any of the preceding examples, wherein identifying the action plan comprises activating an equipment to clean or protect one or more points of interests identified to be affected by the material change pattern.

Example 10. A computer-implemented system comprising: memory storing application programming interface (API) information; and a server performing operations comprising: receiving a multispectral image corresponding to a region of interest, the multispectral image comprising aerial images of the region of interest captured by a multispectral sensor, the multispectral image comprises a plurality of pixels; processing the multispectral image, by applying a multidimensional edge detection filter to remove a portion of the plurality of pixels identified as impure pixels, a remaining portion of plurality of pixels comprising unmasked samples; determine a Euclidian minimum spanning tree of unmasked samples, wherein the unmasked samples are rotated to minimize a dimension of the unmasked samples; applying a single-link clustering to generate a dendrogram of pure materials; determining a cluster quality index for each cluster to sort the pure materials in order of significance and to select a portion of the pure materials as key materials based on the order of significance; applying a spectral unmixing procedure to generate a map of the key materials in the multispectral image; and identifying an action plan to remedy a risk associated with the map of key materials.

Example 11. The computer-implemented system of any of the preceding example, wherein each pixel of the plurality of pixels having an associated spectrum consisting of a plurality of dimensions.

Example 12. The computer-implemented system of the preceding example, wherein applying the multidimensional edge detection filter comprises: locally normalizing edges and subpixel anomalies within the multispectral image using a volatility map; and applying an edge filter mask to remove a portion of the edges and an anomaly filter mask to remove a portion of the subpixel anomalies to generate a map of pure pixels which remain unmasked.

Example 13. The computer-implemented system of any of the preceding examples, wherein applying the single-link clustering comprises:

applying a hierarchical clustering algorithm to the map of pure pixels to generate a dendrogram comprising the clusters of pure materials.

Example 14. The computer-implemented system of any of the preceding examples, wherein identifying and selecting the key materials comprises: calculating a size quality index and a height quality index for each non-leaf cluster in the dendrogram; combining the size quality index and the height quality index to calculate an overall cluster quality index for each cluster; sorting the clusters in descending order of cluster quality index to generate sorted clusters; and selecting a portion of the sorted clusters as the key materials or endmembers used for subsequent processing.

Example 15. The computer-implemented system of any of the preceding examples, wherein a spectral unmixing procedure is applied to generate a map of key materials in the multispectral image.

Example 16. The computer-implemented system of any of the preceding examples, further comprising comparing to the map of materials to a past map of materials to determine a material change pattern.

Example 17. The computer-implemented system of any of the preceding examples, wherein identifying the action plan comprises: determining a risk associated with the material change pattern; and generating an alert indicative of the risk associated with the material change pattern.

Example 18. The computer-implemented system of any of the preceding examples, wherein identifying the action plan comprises activating an equipment to clean or protect one or more points of interests identified to be affected by the material change pattern.

Example 19. A non-transitory computer-readable media encoded with a computer program, the computer program comprising instructions that when executed by one or more computers cause the one or more computers to perform operations comprising: receiving a multispectral image corresponding to a region of interest, the multispectral image comprising aerial images of the region of interest captured by a multispectral sensor, the multispectral image comprises a plurality of pixels; processing the multispectral image, by applying a multidimensional edge detection filter to remove a portion of the plurality of pixels identified as impure pixels, a remaining portion of plurality of pixels comprising unmasked samples; determine a Euclidian minimum spanning tree of unmasked samples, wherein the unmasked samples are rotated to minimize a dimension of the unmasked samples; applying a single-link clustering to generate a dendrogram of pure materials; determining a cluster quality index for each cluster to sort the pure materials in order of significance and to select a portion of the pure materials as key materials based on the order of significance; applying a spectral unmixing procedure to generate a map of the key materials in the multispectral image; and identifying an action plan to remedy a risk associated with the map of key materials.

Example 20. The non-transitory computer-readable media of the preceding example, wherein applying the multidimensional edge detection filter comprises: locally normalizing edges and subpixel anomalies within the multispectral image using a volatility map; applying an edge filter mask to remove a portion of the edges and an anomaly filter mask to remove a portion of the subpixel anomalies to generate a map of pure pixels which remain unmasked; and applying a hierarchical clustering algorithm to the map of pure pixels to generate a dendrogram comprising the clusters of pure materials.

What is claimed is:

1. A computer-implemented method comprising:
receiving a multispectral image corresponding to a region of interest, the multispectral image comprising aerial images of the region of interest captured by a multispectral sensor, the multispectral image comprises a plurality of pixels;
processing the multispectral image, by applying a multidimensional edge detection filter to remove a portion of the plurality of pixels identified as impure pixels, a remaining portion of plurality of pixels comprising unmasked samples;
determine a Euclidian minimum spanning tree of unmasked samples, wherein the unmasked samples are rotated to minimize a dimension of the unmasked samples;
applying a single-link clustering to generate a dendrogram of pure materials;
determining a cluster quality index for each cluster to sort the pure materials in order of significance and to select a portion of the pure materials as key materials based on the order of significance;
applying a spectral unmixing procedure to generate a map of the key materials in the multispectral image; and
identifying an action plan to remedy a risk associated with the map of key materials.

2. The computer-implemented method of claim 1, wherein each pixel of the plurality of pixels having an associated spectrum consisting of a plurality of dimensions.

3. The computer-implemented method of claim 1, wherein applying the multidimensional edge detection filter comprises:
locally normalizing edges and subpixel anomalies within the multispectral image using a volatility map; and
applying an edge filter mask to remove a portion of the edges and an anomaly filter mask to remove a portion of the subpixel anomalies to generate a map of pure pixels which remain unmasked.

4. The computer-implemented method of claim 3, wherein applying the single-link clustering comprises:
applying a hierarchical clustering algorithm to the map of pure pixels to generate a dendrogram comprising the clusters of pure materials.

5. The computer-implemented method of claim 1, wherein identifying and selecting the key materials comprises:
calculating a size quality index and a height quality index for each non-leaf cluster in the dendrogram;
combining the size quality index and the height quality index to calculate an overall cluster quality index for each cluster;
sorting the clusters in descending order of cluster quality index to generate sorted clusters; and
selecting a portion of the sorted clusters as the key materials or endmembers used for subsequent processing.

6. The computer-implemented method of claim 1, wherein a spectral unmixing procedure is applied to generate a map of key materials in the multispectral image.

7. The computer-implemented method of claim 1, further comprising comparing to the map of materials to a past map of materials to determine a material change pattern.

8. The computer-implemented method of claim 7, wherein identifying the action plan comprises:
determining a risk associated with the material change pattern; and
generating an alert indicative of the risk associated with the material change pattern.

9. The computer-implemented method of claim 7, wherein identifying the action plan comprises activating an equipment to clean or protect one or more points of interests identified to be affected by the material change pattern.

10. A computer-implemented system comprising:
memory storing application programming interface (API) information; and
a server performing operations comprising:
receiving a multispectral image corresponding to a region of interest, the multispectral image comprising aerial images of the region of interest captured by a multispectral sensor, the multispectral image comprises a plurality of pixels;
processing the multispectral image, by applying a multidimensional edge detection filter to remove a portion of the plurality of pixels identified as impure pixels, a remaining portion of plurality of pixels comprising unmasked samples;
determine a Euclidian minimum spanning tree of unmasked samples, wherein the unmasked samples are rotated to minimize a dimension of the unmasked samples;
applying a single-link clustering to generate a dendrogram of pure materials;
determining a cluster quality index for each cluster to sort the pure materials in order of significance and to select a portion of the pure materials as key materials based on the order of significance;
applying a spectral unmixing procedure to generate a map of the key materials in the multispectral image; and
identifying an action plan to remedy a risk associated with the map of key materials.

11. The computer-implemented system of claim 10, wherein each pixel of the plurality of pixels having an associated spectrum consisting of a plurality of dimensions.

12. The computer-implemented system of claim 10, wherein applying the multidimensional edge detection filter comprises:
locally normalizing edges and subpixel anomalies within the multispectral image using a volatility map; and
applying an edge filter mask to remove a portion of the edges and an anomaly filter mask to remove a portion of the subpixel anomalies to generate a map of pure pixels which remain unmasked.

13. The computer-implemented system of claim 12, wherein applying the single-link clustering comprises:
applying a hierarchical clustering algorithm to the map of pure pixels to generate a dendrogram comprising the clusters of pure materials.

14. The computer-implemented system of claim 10, wherein identifying and selecting the key materials comprises:
calculating a size quality index and a height quality index for each non-leaf cluster in the dendrogram;
combining the size quality index and the height quality index to calculate an overall cluster quality index for each cluster;
sorting the clusters in descending order of cluster quality index to generate sorted clusters; and
selecting a portion of the sorted clusters as the key materials or endmembers used for subsequent processing.

15. The computer-implemented system of claim 10, wherein a spectral unmixing procedure is applied to generate a map of key materials in the multispectral image.

16. The computer-implemented system of claim 10, further comprising comparing to the map of materials to a past map of materials to determine a material change pattern.

17. The computer-implemented system of claim 16, wherein identifying the action plan comprises:
determining a risk associated with the material change pattern; and
generating an alert indicative of the risk associated with the material change pattern.

18. The computer-implemented system of claim 16, wherein identifying the action plan comprises activating an equipment to clean or protect one or more points of interests identified to be affected by the material change pattern.

19. A non-transitory computer-readable media encoded with a computer program, the computer program comprising instructions that when executed by one or more computers cause the one or more computers to perform operations comprising:
receiving a multispectral image corresponding to a region of interest, the multispectral image comprising aerial images of the region of interest captured by a multispectral sensor, the multispectral image comprises a plurality of pixels;
processing the multispectral image, by applying a multidimensional edge detection filter to remove a portion of the plurality of pixels identified as impure pixels, a remaining portion of plurality of pixels comprising unmasked samples;
determine a Euclidian minimum spanning tree of unmasked samples, wherein the unmasked samples are rotated to minimize a dimension of the unmasked samples;
applying a single-link clustering to generate a dendrogram of pure materials;
determining a cluster quality index for each cluster to sort the pure materials in order of significance and to select a portion of the pure materials as key materials based on the order of significance;
applying a spectral unmixing procedure to generate a map of the key materials in the multispectral image; and
identifying an action plan to remedy a risk associated with the map of key materials.

20. The non-transitory computer-readable media of claim 19, wherein applying the multidimensional edge detection filter comprises:
locally normalizing edges and subpixel anomalies within the multispectral image using a volatility map;
applying an edge filter mask to remove a portion of the edges and an anomaly filter mask to remove a portion of the subpixel anomalies to generate a map of pure pixels which remain unmasked; and
applying a hierarchical clustering algorithm to the map of pure pixels to generate a dendrogram comprising the clusters of pure materials.
